(19) United States
(12) Patent Application Publication
(10) Pub. No.: US 2020/0391650 A1
(43) Pub. Date: Dec. 17, 2020

(54) RUGGED OVERLAND CAMPER TRAILER WITH CONVERTIBLE A-FRAME

(71) Applicant: IKON OUTDOORS, LLC, North Logan, UT (US)

(72) Inventors: ROD LEISHMAN, Smithfield, UT (US); LANCE CHRISTIANSEN, Hyde Park, UT (US); LUKE STEVENSON, Salt Lake City, UT (US); CASEY HIBBARD, River Heights, UT (US)

(73) Assignee: IKON OUTDOORS, LLC, North Logan, UT (US)

(21) Appl. No.: 16/897,454

(22) Filed: Jun. 10, 2020

Related U.S. Application Data
(60) Provisional application No. 62/861,239, filed on Jun. 13, 2019.

(51) Int. Cl. B60P 3/34; B60R 5/02

(52) U.S. Cl. CPC B60P 3/34; B60J 5/10; B60R 5/02

(57) ABSTRACT

The present invention relates to a convertible A-frame structure with top-hinged and connected first and second roof panels that are operable to nest together in a first configuration in which they are generally horizontally stacked, and which are operable to extend, at least in part, along a track to a second configuration in which they form an A-frame roof to the structure.

### RELATED APPLICATIONS

This application claims priority to provisional patent application U.S. Ser. No. 62/861,239, filed on Jun. 13, 2019.

### BACKGROUND OF THE INVENTION

Within outdoor culture, overlanding is a term that describes a form of nimble, self- reliant, and environmentally compatible vehicle-supported adventure travel. Overlanding tends to be more focused on the journey—often to remote locales—and not the destination. This is contrasted with typical car, truck or trailer camping which focuses more on destination using larger and more expensive camper trailers. By their nature, overland dwellings are typically smaller. Existing dwellings in this category often come with a variety of drawbacks. For example, micro- and teardrop camper trailers offer very limited space and standing height. Off road camper trailers are often adapted for extreme and/or infrequent travel conditions, thereby overemphasizing ruggedness at the expense of comfort and amenities. Ultralights, tents and tent trailers sacrifice ruggedness with low quality, lightweight materials and/or fabric walls. A-frames lack versatility by omitting storage and dual-use space options.

What is needed is a new type of overland dwelling which optimizes affordability, size and weight, ruggedness, space/standing height, and storage space as well as other versatility.

### SUMMARY OF THE INVENTION

In accordance with the above, a new and innovative rugged overland camper is provided. The present invention relates to a convertible A-frame structure having a first panel with a first end and second end; a second panel with a first end and second end; a pivotal connection joining the first and second panels at first ends; the first and second panels operable to nest together in a first configuration in which they are generally horizontally stacked; and the first and second panels further operable to extend to a second configuration in which they form an A-frame.

These and other aspects of the present invention will become more fully apparent from the following description and appended claim, or they may be learned by the practice of the invention as set forth hereinafter.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is a side view of one embodiment of a rugged overland camper trailer with convertible A-frame.

FIG. 2 is a first front perspective view of one embodiment of a rugged overland camper trailer with convertible A-frame in a first configuration.

FIG. 3 is a first rear view of one embodiment of a rugged overland camper trailer with convertible A-frame.

FIG. 4 is a second rear view of one embodiment of a rugged overland camper trailer with convertible A-frame.

FIG. 5 is a third rear view of one embodiment of a rugged overland camper trailer with convertible A-frame.

FIG. 6 is a fourth rear view of one embodiment of a rugged overland camper trailer with convertible A-frame.

FIG. 7 is a front perspective view of one embodiment of a rugged overland camper trailer with convertible A-frame in a second configuration.

FIG. 8 is a rear perspective view of one embodiment of a rugged overland camper trailer with convertible A-frame.

FIG. 9 is a cross-section view of paneling in one embodiment of a rugged overland camper trailer with convertible A-frame.

### DETAILED DESCRIPTION OF THE ILLUSTRATED EMBODIMENT

The present invention in its various embodiments, some of which are depicted in the figures herein, is a rugged overland camper trailer with convertible A-frame.

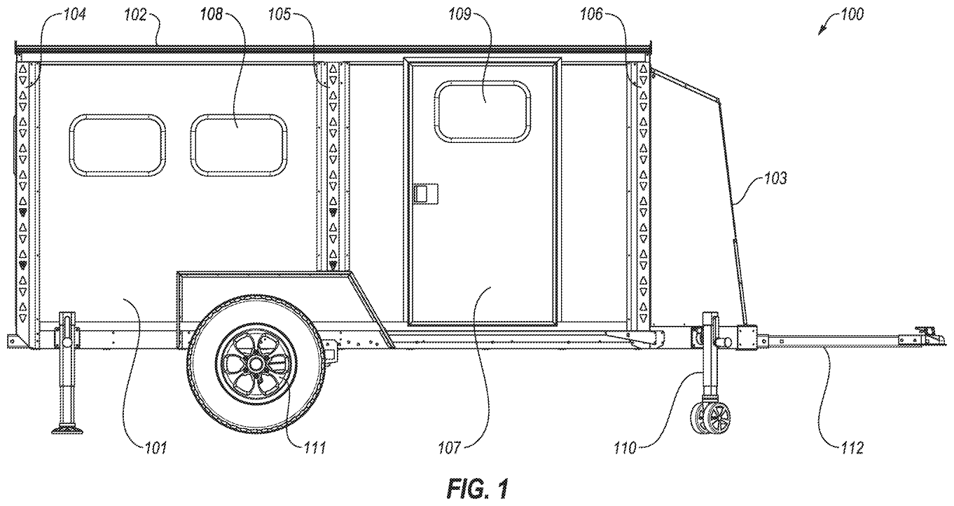

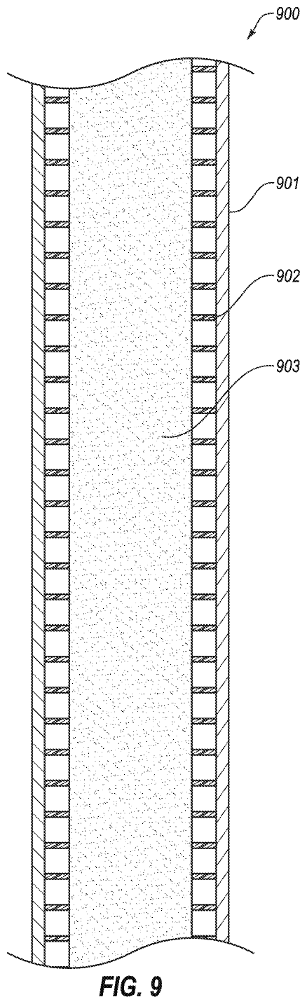

Referring now to FIG. 1, the rugged overland camper trailer with convertible A-frame 100 has a lower body portion with front 103, back, left 101, and right sides, as well as a top 102 and bottom. The lower body portion is generally rectangular in a first trailer configuration. Referring briefly to the cross-section of FIG. 9, sides are preferably constructed of rugged panels 900. For example, rugged panels 900 may be between 0.5 and 1.5 inches in overall width, with one or more exterior aluminum layers 901 of between 0.01 and 0.05 inch, one or more interior polymer (e.g. polypropylene) layers 902, and one or more interior foam (e.g., polystyrene) layers 903. However, any number of suitable materials with comparable properties may be used for the rugged panels without departing from the purpose and scope of the invention.

Referring back to FIG. 1, rugged overland camper trailer with convertible A-frame 100 has an axle with wheels 111 and tongue 112 for towed vehicle transport. The size and weight of rugged overland camper trailer with convertible A-frame 100 are adapted so that it may be towed by trucks, but just as easily by smaller vehicles such as cars, crossovers, jeeps, small SUVs, and the like. Rugged overland camper trailer with convertible A-frame 100 is supported by a rugged exoskeletal support system comprised of a plurality of exterior vertical support units 104, 105, 106 (shown on the left side; corresponding units on the right side not labeled). In various embodiments, exterior vertical support units are shaped, hollowed, and/or cutout aluminum and may be placed adjacent to and/or between vertices of overland camper trailer sides. Support units may have a matrix of triangle cutouts to optimize weight-strength ratios. Rugged overland camper trailer with convertible A-frame 100 may include one or more user access doors 107 and/or windows 108, 109.

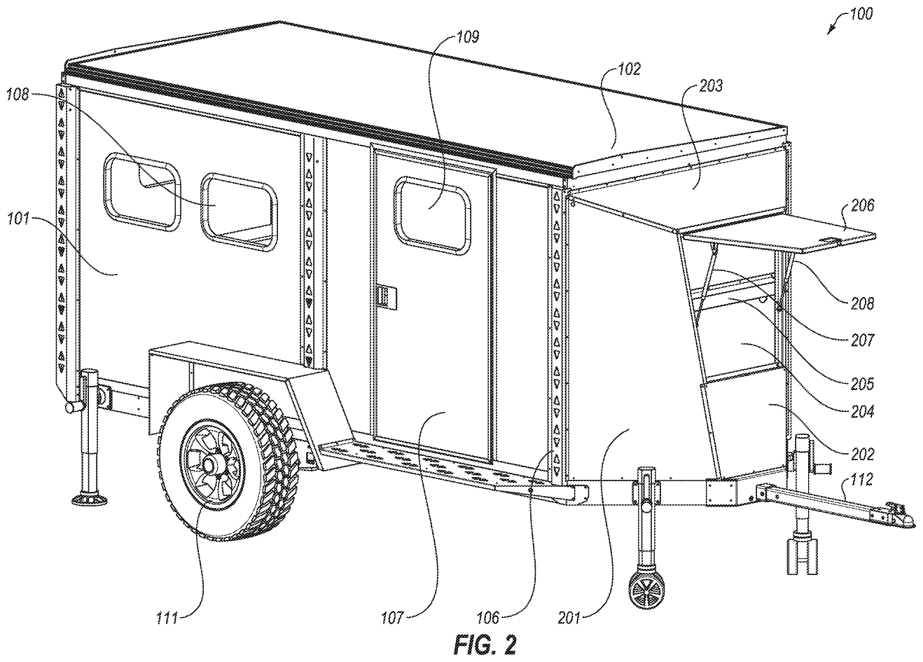

Referring now to FIG. 2, rugged overland camper trailer with convertible A-frame 100 may have a generally angled and/or trapezoidal front 103 comprised of sides, e.g., 201, 202, 203. Front 103 may house one or more storage compartments 204 formed by sides 201, 202, 203 and including one or more shelves 205 and/or access doors 206. One or more access doors 206 may be spring-, pneumatic-, or otherwise assisted 207, 208. FIG. 2 shows an access door 205 in open position.

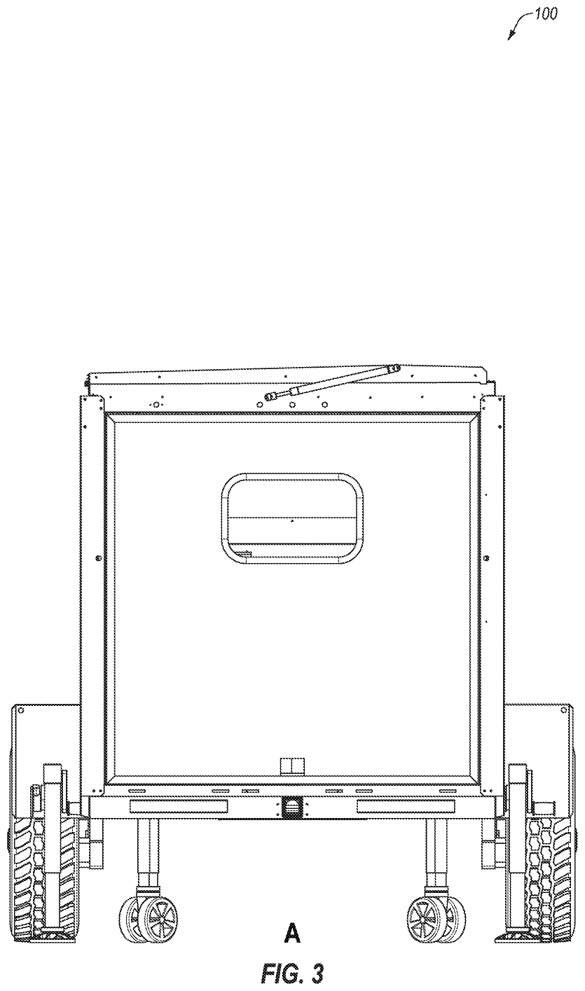

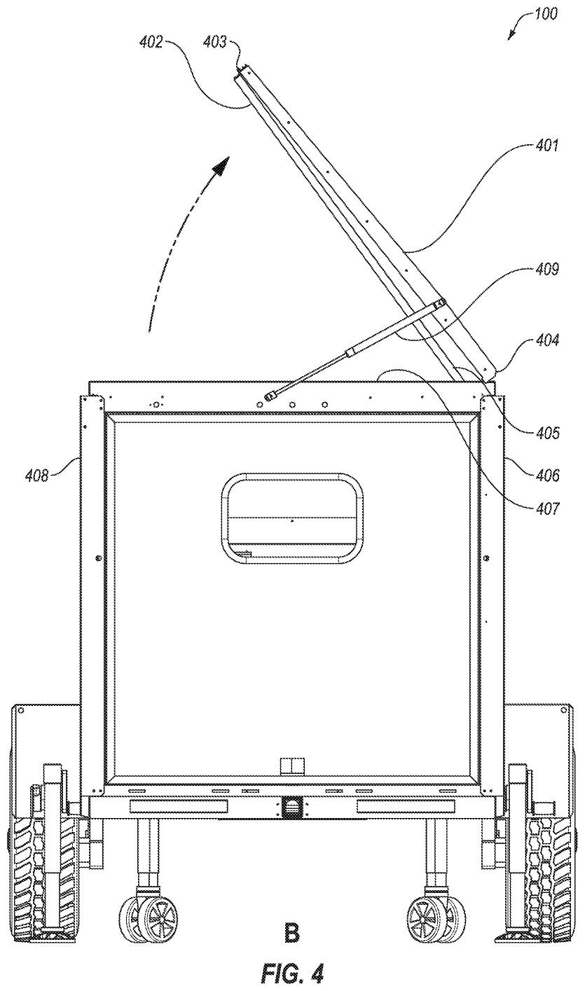

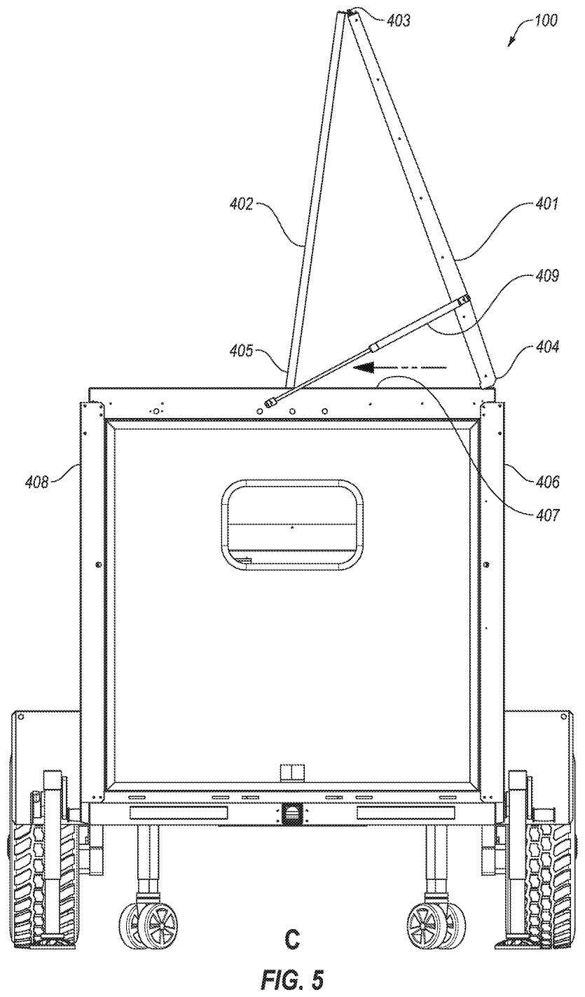

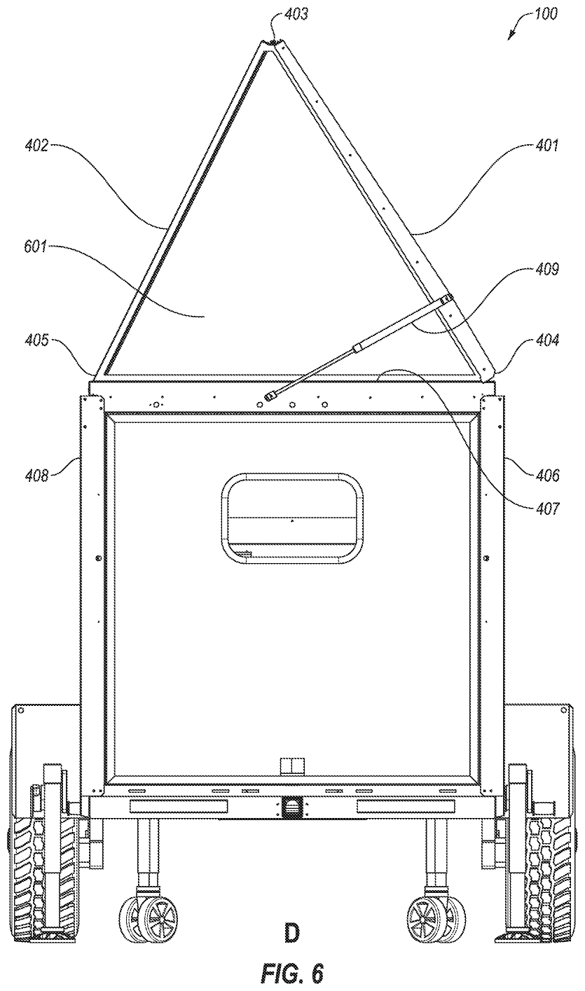

Referring now to FIGS. 3 through 6, rugged overland camper trailer with 100 has a convertible A-frame roof system that achieves a second trailer configuration by moving roof panels from a nested position A—where they form a generally planar and horizontal top side of the rugged overland camper trailer 100—to deployed positions D and/or F where they form an A-frame roof that substantially expands the interior volume of the trailer 100.

The convertible A-frame roof system is comprised of a first roof panel 401 with a first and second end 404, and a second roof panel 402 with a first and second end 405. First 401 and second 402 roof panels may be constructed of the same materials as set forth previously herein, namely, aluminum, polymer, and foam, or any other suitable materials. A first pivotal connection 403 joins the first 401 and second 402 roof panels at first ends and/or along an edge. First 401 and second 402 roof panels are therefore pivotally hinged together at first ends. First roof panel second end 404 and second roof panel second end 405 are separable from each other. First roof panel second end 404 is pivotally affixed adjacent to a trailer side 406, thereby forming a second pivotal connection at a stationary axis distal to the first pivotal connection 403. Second panel second end 405 is fixed to a track 407 adjacent to a trailer back side and is configured to travel linearly along the track 407 between roof panel positions, and away from and/or towards the first panel second end 404.

With the forgoing structure, convertible A-frame roof system deploys from nested Position A when first 401 and second 402 roof panels are pushed up by a user from a generally horizontally stacked configuration towards a trailer side 406, as shown in Position B. In various embodiments this movement may be spring-, pneumatic- 409, or otherwise assisted. Next, second panel second end 405 is pushed and/or pulled along the track 407 to the opposite trailer side 408, as shown in Position C. When the A-frame roof system is fully deployed it forms an A-frame roof for the overland camper trailer 100 providing substantial standing height of between 7 and 10 feet (and in preferred embodiments 9 feet) as well as interior volume 601. In certain embodiments, second panel second end 405 may be secured in Position D by a locking mechanism such as a latch adjacent the right trailer side 408.

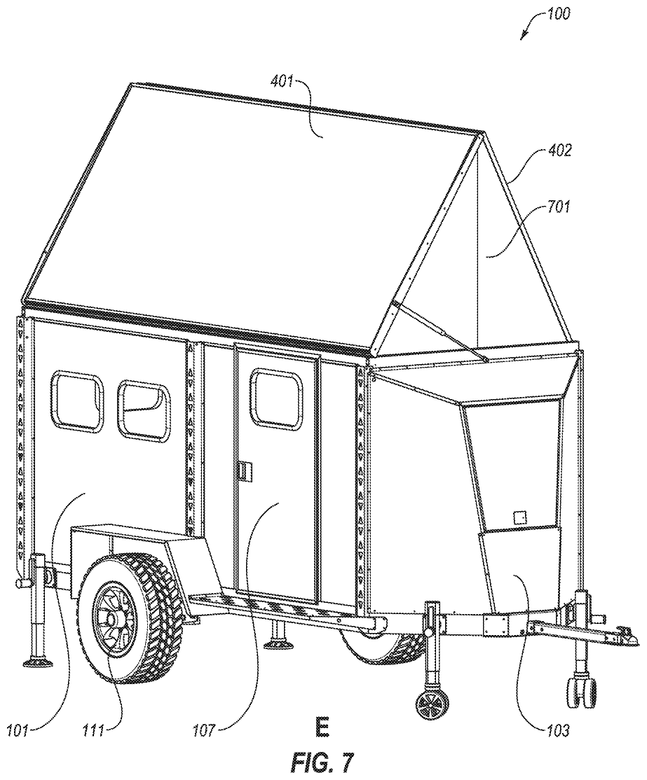

Referring briefly to FIG. 7, in certain embodiments, the A-frame roof system also includes one or more end panels 701 to bound interior volume 601 and provide for a fully enclosed dwelling structure, shown in Position E. In certain embodiments, one or more such end panels 701 may be pivotally attached and nestable adjacent to first 401 and/or second 402 roof panels.

In various embodiments, the convertible A-frame structure may exist separately from any trailer portion as a standalone unit. For example, in certain commercial embodiments, the A-frame structure may be configured as a system for mounting on top of a separate vehicle instead of affixed to a trailer.

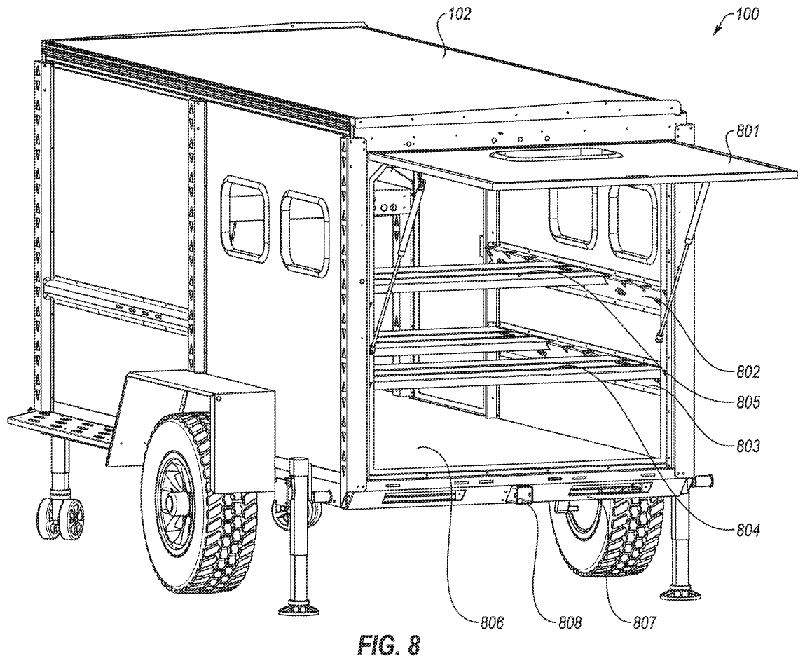

Referring now to FIG. 8, rugged overland camper trailer with convertible A-frame roof 100 may have a variety of other structures and functionality. For example, overland camper trailer 100 may have a back end that forms an access door 801. Back end access door 801 may be configured so as to provide a large access and/or substantially open end for loading and/or unloading equipment or accessories. In the illustrated embodiment, the back-end access door 801 pivots vertically along a hinge adjacent to the top 102 of the rugged overland camper trailer 100. Rugged overland camper trailer interior 806 may also include mounting and/or bracket systems 802, 803, 804, 805 for shelving, beds, and other features. Rugged overland camper trailer 100 may include nesting ramps 807 for loading large equipment like ATVs, motorcycles, bikes, and the like. Overland camper trailer 100 may also include hitch mounts 808 for other accessories. In certain embodiments, the exoskeletal support system may also be adapted as a modular rack, storage, shelving, and/or tool system.

Thus configured, among other features the rugged overland camper described above provides for a trailer with convertible A-frame roof comprising a first roof panel with a first end and second end; a second roof panel with a first end and second end, a pivotal connection joining the first and second roof panels at first ends; the first and second roof panels operable to nest together in a first configuration in which they are generally horizontally stacked; the first and second roof panels further operable to extend to a second configuration in which they form an A-frame; and the first and second roof panel second ends located opposite the pivotal connection and adjacent to each other when the roof panels are in the first configuration. The camper optimizes expense, size and weight, ruggedness, space/standing height, and storage space as well as other versatility.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A convertible A-frame structure comprising:
a first panel with a first end and second end;
a second panel with a first end and second end;
a pivotal connection joining the first and second panels at first ends;
the first and second panels operable to nest together in a first configuration in which they are generally horizontally stacked; and
the first and second panels further operable to extend to a second configuration in which they form an A-frame.

2. The convertible A-frame structure of claim 1, the first and second panel second ends located opposite the pivotal connection and adjacent to each other when the panels are in the first configuration.

3. The convertible A-frame structure of claim 1, the second panel second end operable to travel along a fixed track between the first and second configurations.

4. The convertible A-frame structure of claim 1, wherein of the first and second roof panels, only the first roof panel pivots at a stationary axis.

5. The convertible A-frame structure of claim 1, substantially constructed of one or more hard panels.

6. A trailer with a convertible A-frame roof comprising:
a first roof panel with a first end and second end;
a second roof panel with a first end and second end;
a pivotal connection joining the first and second roof panels at first ends;
the first and second roof panels operable to nest together in a first configuration in which they are generally horizontally stacked;
the first and second roof panels further operable to extend to a second configuration in which they form an A-frame; and
the first and second roof panel second ends located opposite the pivotal connection and adjacent to each other when the roof panels are in the first configuration.

7. The trailer with a convertible A-frame roof of claim 6, the second panel second end operable to travel along a fixed track between the first and second configurations.

8. The trailer with a convertible A-frame roof of claim 6, wherein of the first and second roof panels, only the first roof panel pivots at a stationary axis.

9. The trailer with a convertible A-frame roof of claim 6, further comprising an exoskeletal support system comprised of a plurality of exterior vertical support units.

10. The trailer with a convertible A-frame roof of claim 6, substantially constructed of one or more hard panels.

11. The camper trailer of claim 6, further comprising a generally trapezoidal encloseable front storage compartment.

12. A rugged overland camper trailer comprising:
a generally rectangular lower body portion with front, back, left, and right sides and a convertible A-frame roof comprising:
a first roof panel with a first end and second end;
a second roof panel with a first end and second end;
a pivotal connection joining the first and second roof panels at first ends;
the first and second roof panels operable to nest together in a first configuration in which they are generally horizontally stacked;
the first and second roof panels further operable to extend to a second configuration in which they form an A-frame; and
the first and second roof panel second ends located opposite the pivotal connection and adjacent to each other when the roof panels are in the first configuration.

13. The rugged overland camper trailer of claim 12, the second panel second end operable to travel along a fixed track between the first and second configurations.

14. The rugged overland camper trailer of claim 12 wherein of the first and second roof panels, only the first roof panel pivots at a stationary axis.

15. The rugged overland camper trailer of claim 12, further comprising an exoskeletal support system comprised of a plurality of exterior vertical support units formed of hollow metal beams.

16. The rugged overland camper trailer of claim 12, wherein each side of the trailer is substantially constructed of one or more metal panels.

17. The rugged overland camper trailer of claim 12, further comprising a generally trapezoidal encloseable front storage compartment.

18. The rugged overland camper trailer of claim 12, further comprising a back access door configured to open the entire back side of the trailer.
